(19) United States
(12) Patent Application Publication
(10) Pub. No.: US 2026/0299991 A1
(43) Pub. Date: Oct. 1, 2026

(54) DYNAMIC SPAWNING OF OBSERVER VIRTUAL MACHINES BASED ON MONITOR PROCESSES

(71) Applicant: Nutanix, Inc., San Jose, CA (US)

(72) Inventors: Adil Gul Rather, Bangalore (IN); Altaf Mahmood, Bangalore (IN); Jagadeesh Dittakavi, Bangalore (IN)

(73) Assignee: Nutanix, Inc., San Jose, CA (US)

(21) Appl. No.: 19/205,946

(22) Filed: May 12, 2025

(30) Foreign Application Priority Data
Mar. 26, 2025 (IN) 202541028389

(51) Int. Cl. G06F 9/455

(52) U.S. Cl. CPC G06F 9/45558; G06F 2009/45562; G06F 2009/45591

(57) ABSTRACT

A method may include monitoring, by a monitor on a first cluster, a health of an observer hosted on a second cluster, in response to determining, by the monitor, that the observer is unavailable, determining, by the monitor, whether the observer is unavailable due to a failure of an observer process, a failure of the observer VM, or a failure of the second cluster, and in response to the observer being unavailable due to the failure of the observer VM, spawning, by the monitor, a new observer VM on the second cluster, or in response to the observer being unavailable due to the failure of the second cluster, spawning, by the monitor, the new observer VM on a fourth cluster.

### CROSS-REFERENCE TO RELATED APPLICATIONS

This application claims priority to Indian Provisional Application No.: 202541028389 filed Mar. 26, 2025, which application is incorporated herein by reference in its entirety.

### BACKGROUND

Data from a primary database can be replicated to a secondary database as a backup to guard against data loss. In order to prevent data loss, failover from the primary database to the secondary database is performed in the event of a failure of the primary database. An observer VM can determine when to perform the failover from the primary database to the secondary database based on a status of the primary database.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is a block diagram of an example cluster of a virtual computing system, in accordance with some embodiments of the present disclosure.

FIG. 2 is a block diagram of an example database management system, in accordance with some embodiments of the present disclosure.

FIG. 3A is a block diagram of an example computing environment including three clusters hosting a primary database, a secondary database, and a cascaded database.

FIG. 3B is a block diagram of the computing environment of FIG. 3A after a failure of the third cluster.

FIG. 4A is a block diagram of an example computing environment including five clusters hosting a primary database, a secondary database, and a cascaded database.

FIG. 4B is a block diagram of the computing environment of FIG. 4A after a failure of the fourth cluster.

FIG. 5 illustrates operations of a flow chart of an example method for dynamically spawning observer virtual machines (VMs) based on monitor processes.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Database failure can result in data loss and application downtime. To avoid data loss and application downtime, a backup or secondary database can be used to store a backup of data stored in a database. Data from a primary database is replicated to a secondary database in order to avoid loss of data in the event of a failure of the primary database. To avoid application downtime, the secondary database can be used in place of the primary database in the event of a failure of the primary database. To avoid application downtime between the failure of the primary database and the use of the secondary database, automatic failover procedures and systems can be used to automatically transition application execution to the secondary database in response to the failure of the primary database. An example of an automatic failover system is ORACLE DATA GUARD. Automatic failover systems can operate in systems where more than one backup database (e.g., secondary database and cascaded database) is used to back up data of the primary database.

However, there are significant challenges to ensuring reliable failover that automatic failover systems do not address. Automatic failover systems require a mechanism to determine when a failover is needed (i.e., whether the primary database has failed). An observer process (also referred to herein as an “observer”) can be executed on a computing system (e.g., cluster) hosting the primary database, a computing system hosting the secondary database, or another computing system. Failure of the observer, or a host of the observer, can prevent the automatic failover. Thus, the observer can become a single point of failure of the automatic failover system, preventing failover from the primary database to the second database and resulting in data loss and/or application downtime.

Examples and embodiments discussed herein solve this technical problem to provide reliable and resilient automatic failover. Aspects of the present disclosure are directed to one or more monitor processes (i.e., monitors) to monitor the health and availability of the observer and/or network latency between the observer and the primary database. In this way, the one or more monitors provide an additional layer of resiliency to the automatic failover system, ensuring that the observer is not a single point of failure. The one or more monitors, in response to the observer being unreachable or network latency rising above a predetermined threshold, can automatically spawn a new observer (e.g., new observer VM) to maintain the structure of the automatic failover system. The one or more monitors can be computationally less expensive and/or smaller than the observer to increase the resiliency of the automatic failover system in an efficient manner. Furthermore, the one or more monitors can run on control plane agent VMs, using the resources already allocated to these VMs and thus not requiring any additional allocation of resources.

In some implementations, the one or more monitors include two monitors to monitor the observer, the network latency, and each other. By monitoring each other, the two monitors prevent monitor failure from compromising the automatic failover system. Monitoring of the observer and the network latency using two monitors provides increased accuracy in identifying problems. By requiring consensus between the two monitors (i.e., the two monitors identify the same problem), problems with a single monitor prevent premature spawning of a new observer. If a single monitor determines that the observer is unreachable, a new observer is not spawned, as an alert from the single monitor might indicate a problem with the monitor instead of the observer. Instead, the two monitors perform an inter-monitor health check to assess each other's status. If a monitor is unhealthy (e.g., unstable, high latency, etc.), a new monitor can be spawned. In this way, inefficient and ineffective spawning of new observers can be avoided, ensuring that new observers are spawned to strengthen the resiliency of the automatic failover system.

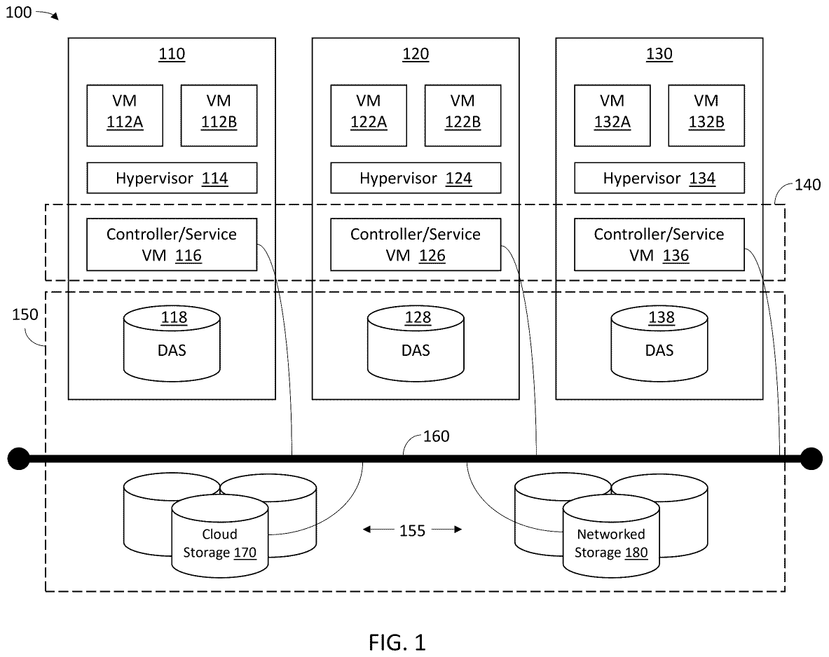

FIG. 1 is a block diagram of an example cluster 100 of a virtual computing system, in accordance with some embodiments of the present disclosure. The cluster 100 may be incorporated in a cloud based implementation, an on-premises implementation, or a combination of both. An on-premises implementation may be a datacenter that is not part of a cloud. In an example, an organization's servers that it owns and controls for its use can be an on-premises implementation. The cluster 100 may be part of a hyperconverged system or any other type of system. The cluster 100 includes a plurality of nodes, such as a first node 110, a second node 120, and a third node 130. Each of the first node 110, the second node 120, and the third node 130 may also be referred to as a “host” or “host machine.” The first node 110 includes database virtual machines (“database VMs”) 112A and 112B (collectively referred to herein as “database VMs 112”), a hypervisor 114 configured to create and run the database VMs, and a controller/service VM 116 configured to manage, route, and otherwise handle workflow requests between the various nodes of the cluster 100. Similarly, the second node 120 includes database VMs 122A and 122B (collectively referred to herein as “database VMs 122”), a hypervisor 124, and a controller/service VM 126, and the third node 130 includes database VMs 132A and 132B (collectively referred to herein as “database VMs 132”), a hypervisor 134, and a controller/service VM 136. The controller/service VM 116, the controller/service VM 126, and the controller/service VM 136 are all connected to a network 160 to facilitate communication between the first node 110, the second node 120, and the third node 130. Although not shown, in some embodiments, the hypervisor 114, the hypervisor 124, and the hypervisor 134 may also be connected to the network 160. Further, although not shown, one or more of the first node 110, the second node 120, and the third node 130 may include one or more containers managed by a monitor (e.g., container system). In some embodiments, the controller/service VMs 116, 126, and 136 are not included in the cluster 100. The controller/service VMs 116, 126, and 136 may be in a first domain while the VMs 112, 122, and 132 are in a second domain. In an example, the controller/service VMs 116, 126, 136 are in a first cloud, the VMs 112 are in a second cloud, the VMs 122 are in a third cloud, and the VMs 132 are in a fourth cloud. In another example, the controller/service VMs 116, 126, 136 are in a first AWS account and the VMs 112, 122, and 132 are each in different, separate AWS accounts. Thus, the nodes 110, 120, and 130 may be nodes of various public or private clouds, with the controller/service VMs 116, 126, and 136 being separate from the VMs 112, 122, and 132. In an example, the controller/service VMs 116, 126, and 136 host a distributed control plane for managing the VMs 112, 122, and 132, where the VMs 112, 122, and 132 are database server VMs in public cloud accounts separate from a cloud account associated with the control plane.

The controller/service VMs 116, 126, and 136 can be considered a control plane and the VMs 112, 122, and 132 can be considered a data plane. The data plane may include data which is separate from the control logic executed on the control plane. VMs may be added to or removed from the data plane. AS discussed above, the control plane and the data plane may be in separate cloud accounts. Different VMs in the data plane may be in separate cloud accounts. In an example, the control plane is in a cloud account of a database management platform provider and the data plane is in cloud accounts of customers of the database management platform provider.

The cluster 100 also includes and/or is associated with a storage pool 150 (also referred to herein as storage sub-system). The storage pool 150 may include network-attached storage 155 and direct-attached storage 118, 128, and 138. The network-attached storage 155 is accessible via the network 160 and, in some embodiments, may include cloud storage 170, as well as a networked storage 180. In contrast to the network-attached storage 155, which is accessible via the network 160, the direct-attached storage 118, 128, and 138 includes storage components that are provided internally within each of the first node 110, the second node 120, and the third node 130, respectively, such that each of the first, second, and third nodes may access its respective direct-attached storage without having to access the network 160.

It is to be understood that only certain components of the cluster 100 are shown in FIG. 1. Nevertheless, several other components that are needed or desired in the cluster 100 to perform the functions described herein are contemplated and considered within the scope of the present disclosure.

Although three of the plurality of nodes (e.g., the first node 110, the second node 120, and the third node 130) are shown in the cluster 100, in other embodiments, greater than or fewer than three nodes may be provided within the cluster. Likewise, although only two database VMs (e.g., the database VMs 112, the database VMs 122, the database VMs 132) are shown on each of the first node 110, the second node 120, and the third node 130, in other embodiments, the number of the database VMs on each of the first, second, and third nodes may vary to include other numbers of database VMs. Further, the first node 110, the second node 120, and the third node 130 may have the same number of database VMs (e.g., the database VMs 112, the database VMs 122, the database VMs 132) or different number of database VMs.

In some embodiments, each of the first node 110, the second node 120, and the third node 130 may include a hardware device, such as a server. For example, in some embodiments, one or more of the first node 110, the second node 120, and the third node 130 may include a server computer provided by Nutanix, Inc., Dell, Inc., Lenovo Group Ltd. or Lenovo PC International, Cisco Systems, Inc., etc. In other embodiments, one or more of the first node 110, the second node 120, or the third node 130 may include another type of hardware device, such as a personal computer, an input/output or peripheral unit such as a printer, or any type of device that is suitable for use in a node within the cluster 100. In some embodiments, the cluster 100 may be part of one or more data centers. Further, one or more of the first node 110, the second node 120, and the third node 130 may be organized in a variety of network topologies. Each of the first node 110, the second node 120, and the third node 130 may also be configured to communicate and share resources with each other via the network 160. For example, in some embodiments, the first node 110, the second node 120, and the third node 130 may communicate and share resources with each other via the controller/service VM 116, the controller/service VM 126, and the controller/service VM 136, and/or the hypervisor 114, the hypervisor 124, and the hypervisor 134.

Also, although not shown, one or more of the first node 110, the second node 120, and the third node 130 may include one or more processing units configured to execute instructions. The instructions may be carried out by a special purpose computer, logic circuits, or hardware circuits of the first node 110, the second node 120, and the third node 130. The processing units may be implemented in hardware, firmware, software, or any combination thereof. The term “execution” is, for example, the process of running an application or the carrying out of the operation called for by an instruction. The instructions may be written using one or more programming languages, scripting languages, assembly language, etc. The processing units, thus, execute an instruction, meaning that they perform the operations called for by that instruction.

The processing units may be operably coupled to the storage pool 150, as well as with other elements of the first node 110, the second node 120, and the third node 130 to receive, send, and process information, and to control the operations of the underlying first, second, or third node. The processing units may retrieve a set of instructions from the storage pool 150, such as, from a permanent memory device like a read only memory (“ROM”) device and copy the instructions in an executable form to a temporary memory device that is generally some form of random access memory (“RAM”). The ROM and RAM may both be part of the storage pool 150, or in some embodiments, may be separately provisioned from the storage pool. In some embodiments, the processing units may execute instructions without first copying the instructions to the RAM. Further, the processing units may include a single stand-alone processing unit, or a plurality of processing units that use the same or different processing technology.

With respect to the storage pool 150 and particularly with respect to the direct-attached storage 118, 128, and 138, each of the direct-attached storage may include a variety of types of memory devices that are suitable for a virtual computing system. For example, in some embodiments, one or more of the direct-attached storage 118, 128, and 138 may include, but is not limited to, any type of RAM, ROM, flash memory, magnetic storage devices (e.g., hard disk, floppy disk, magnetic strips, etc.), optical disks (e.g., compact disk (“CD”), digital versatile disk (“DVD”), etc.), smart cards, solid state devices, etc. Likewise, the network-attached storage 155 may include any of a variety of network accessible storage (e.g., the cloud storage 170, the networked storage 180, etc.) that is suitable for use within the cluster 100 and accessible via the network 160. The storage pool 150, including the network-attached storage 155 and the direct-attached storage 118, 128, and 138, together form a distributed storage system configured to be accessed by each of the first node 110, the second node 120, and the third node 130 via the network 160, the controller/service VM 116, the controller/service VM 126, the controller/service VM 136, and/or the hypervisor 114, the hypervisor 124, and the hypervisor 134. In some embodiments, the various storage components in the storage pool 150 may be configured as virtual disks for access by the database VMs 112, the database VMs 122, and the database VMs 132.

Each of the database VMs 112, the database VMs 122, the database VMs 132 is a software-based implementation of a computing machine. The database VMs 112, the database VMs 122, the database VMs 132 emulate the functionality of a physical computer. Specifically, the hardware resources, such as processing unit, memory, storage, etc., of the underlying computer (e.g., the first node 110, the second node 120, and the third node 130) are virtualized or transformed by the respective hypervisor 114, the hypervisor 124, and the hypervisor 134, into the underlying support for each of the database VMs 112, the database VMs 122, the database VMs 132 that may run its own operating system and applications on the underlying physical resources just like a real computer. By encapsulating an entire machine, including CPU, memory, operating system, storage devices, and network devices, the database VMs 112, the database VMs 122, the database VMs 132 are compatible with most standard operating systems (e.g. Windows, Linux, etc.), applications, and device drivers.

Thus, each of the hypervisor 114, the hypervisor 124, and the hypervisor 134 is a virtual machine monitor that allows a single physical server computer (e.g., the first node 110, the second node 120, third node 130) to run multiple instances of the database VMs 112, the database VMs 122, and the database VMs 132 with each VM sharing the resources of that one physical server computer, potentially across multiple environments. For example, each of the hypervisor 114, the hypervisor 124, and the hypervisor 134 may allocate memory and other resources to the underlying VMs (e.g., the database VMs 112, the database VMs 122, and the database VMs 132) from the storage pool 150 to perform one or more functions.

By running the database VMs 112, the database VMs 122, and the database VMs 132 on each of the first node 110, the second node 120, and the third node 130, respectively, multiple workloads and multiple operating systems may be run on a single piece of underlying hardware computer (e.g., the first node, the second node, and the third node) to increase resource utilization and manage workflow. When new database VMs are created (e.g., installed) on the first node 110, the second node 120, and the third node 130, each of the new database VMs may be configured to be associated with certain hardware resources, software resources, storage resources, and other resources within the cluster 100 to allow those virtual VMs to operate as intended.

The database VMs 112, the database VMs 122, the database VMs 132, and any newly created instances of the database VMs may be controlled and managed by their respective instance of the controller/service VM 116, the controller/service VM 126, and the controller/service VM 136. The controller/service VM 116, the controller/service VM 126, and the controller/service VM 136 are configured to communicate with each other via the network 160 to form a distributed system 140. Each of the controller/service VM 116, the controller/service VM 126, and the controller/service VM 136 may be considered a local management system configured to manage various tasks and operations within the cluster 100. For example, in some embodiments, the local management system may perform various management related tasks on the database VMs 112, the database VMs 122, and the database VMs 132.

The hypervisor 114, the hypervisor 124, and the hypervisor 134 of the first node 110, the second node 120, and the third node 130, respectively, may be configured to run virtualization software, such as, ESXi from VMWare, AHV from Nutanix, Inc., XenServer from Citrix Systems, Inc., etc. The virtualization software on the hypervisor 114, the hypervisor 124, and the hypervisor 134 may be configured for running the database VMs 112, the database VMs 122, the database VM 132A, and the database VM 132B, respectively, and for managing the interactions between those VMs and the underlying hardware of the first node 110, the second node 120, and the third node 130. Each of the controller/service VM 116, the controller/service VM 126, the controller/service VM 136, the hypervisor 114, the hypervisor 124, and the hypervisor 134 may be configured as suitable for use within the cluster 100.

The network 160 may include any of a variety of wired or wireless network channels that may be suitable for use within the cluster 100. For example, in some embodiments, the network 160 may include wired connections, such as an Ethernet connection, one or more twisted pair wires, coaxial cables, fiber optic cables, etc. In other embodiments, the network 160 may include wireless connections, such as microwaves, infrared waves, radio waves, spread spectrum technologies, satellites, etc. The network 160 may also be configured to communicate with another device using cellular networks, local area networks, wide area networks, the Internet, etc. In some embodiments, the network 160 may include a combination of wired and wireless communications. The network 160 may also include or be associated with network interfaces, switches, routers, network cards, and/or other hardware, software, and/or firmware components that may be needed or considered desirable to have in facilitating intercommunication within the cluster 100.

Referring still to FIG. 1, in some embodiments, one of the first node 110, the second node 120, or the third node 130 may be configured as a leader node. The leader node may be configured to monitor and handle requests from other nodes in the cluster 100. For example, a particular database VM (e.g., the database VMs 112, the database VMs 122, or the database VMs 132) may direct an input/output request to the controller/service VM (e.g., the controller/service VM 116, the controller/service VM 126, or the controller/service VM 136, respectively) on the underlying node (e.g., the first node 110, the second node 120, or the third node 130, respectively). Upon receiving the input/output request, that controller/service VM may direct the input/output request to the controller/service VM (e.g., one of the controller/service VM 116, the controller/service VM 126, or the controller/service VM 136) of the leader node. In some cases, the controller/service VM that receives the input/output request may itself be on the leader node, in which case, the controller/service VM does not transfer the request, but rather handles the request itself.

The controller/service VM of the leader node may fulfill the input/output request (and/or request another component within/outside the cluster 100 to fulfill that request). Upon fulfilling the input/output request, the controller/service VM of the leader node may send a response back to the controller/service VM of the node from which the request was received, which in turn may pass the response to the database VM that initiated the request. In a similar manner, the leader node may also be configured to receive and handle requests (e.g., user requests) from outside of the cluster 100. If the leader node fails, another leader node may be designated.

Additionally, in some embodiments, although not shown, the cluster 100 may be associated with a central management system that is configured to manage and control the operation of multiple clusters in the virtual computing system. In some embodiments, the central management system may be configured to communicate with the local management systems on each of the controller/service VM 116, the controller/service VM 126, the controller/service VM 136 for controlling the various clusters.

Again, it is to be understood again that only certain components and features of the cluster 100 are shown and described herein. Nevertheless, other components and features that may be needed or desired to perform the functions described herein are contemplated and considered within the scope of the present disclosure. It is also to be understood that the configuration of the various components of the cluster 100 described above is only an example and is not intended to be limiting in any way. Rather, the configuration of those components may vary to perform the functions described herein. For example, in some embodiments, the VMs 112, 122, and 132 are not in the same nodes as the controller/service VMs 116, 126, 136. The VMs 112, 122, and 132 may be located in a different cloud than the controller/service VMs 116, 126, 136.

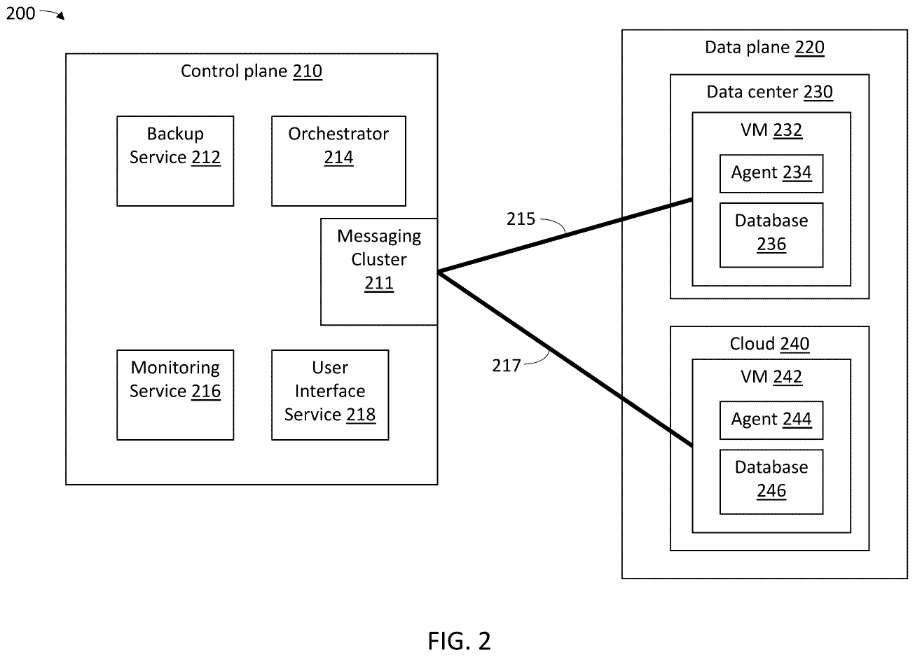

FIG. 2 is a block diagram of an example database management system 200, in accordance with some embodiments of the present disclosure. The database management system 200 may be implemented using one or more clusters, such as the cluster 100 of FIG. 1. In some implementations, one or more components of the database management system 200 are implemented as clusters.

The database management system 200 includes a control plane 210 and a data plane 220. The control plane 210 manages database operations of databases on the data plane 220. The data plane 220 may include databases and virtual machines across multiple different geographies, data centers, public clouds and/or private clouds. Thus, the control plane 210 may manage database operations across multiple different geographies, data centers, public clouds and/or private clouds. The control plane 210 may provide hybrid cloud database management services for databases having instances both on-premises and in public clouds. The control plane 210 may include one or more processors and a memory including computer-readable instructions which cause the one or more processors to perform operations described herein.

The data plane 220 includes a first VM 232 and a second VM 242. The first VM 232 may be hosted in a data center 230. The second VM may be hosted on a cloud 240 such as a public or private cloud and be associated with a cloud account. The first VM 232 includes a first agent 234 of the control plane 210 and a first database 236. The first agent 234 receives commands and operations from the control plane 210 and transmits information to the control plane 210 to provide database management services for the first database 236. The second VM includes a second agent 244 of the control plane 210 and a second database 246. The second agent 244 receives commands and operations from the control plane 210 and transmits information to the control plane 210 to provide database management services for the second database 246.

While the data plane 220 is illustrated as including the first VM 232 hosted in the data center 230 and the second VM 242 hosted on the cloud 240, the data plane 220 may manage database operations of (e.g., send commands to) a plurality of VMs hosted across multiple public clouds, private clouds, and/or on-premises systems. Similarly, the data center 230 may host a plurality of VMs and may include one or more on-premises systems and/or components of a public cloud or private cloud. The control plane 210 may be able to manage database operations of the plurality of VMs across the multiple public clouds, private clouds, and/or on-premises systems by sending commands, modified based on the hosting location, to the plurality of VMs. In this way, the control plane 210 provides a unified user interface for managing VMs in a hybrid cloud environment spanning on-premises systems, public clouds, and private clouds.

The first and second VMs 232, 242 may be termed “database servers,” as they serve as virtual database servers for hosting the first and second databases 236, 246. The first and second VMs 232, 242 may be hosted on clusters of nodes, such as the cluster 100 of FIG. 1.

The first agent 234 sends and receives messages from the control plane 210 over a first single communication channel 215. The second agent 244 sends and receives messages from the control plane 210 over a second single communication channel 217. Each of the first and second single communication channels 215, 217 may be single transmission control protocol (TCP) connections. In this way, the control plane 210 is able to open only a single communication channel for each agent associated with each database. Although two VMs are illustrated, the control plane 210 may provide database management services for hundreds, thousands, or millions of VMs. With hundreds of VMs, limiting the number of connections between the control plane 210 and each VM conserves a large amount of compute and network resources.

The control plane 210 includes a messaging cluster 211. The messaging cluster 211 may be a cluster of nodes such as the cluster 100 of FIG. 1 executing a messaging service or messaging application. The messaging cluster 211 may receive messages from the first agent 234 over the first single communication channel 215 and messages from the second agent 244 over the second single communication channel 217. The messaging cluster 211 may isolate messages between different VMs. In an example, the messaging cluster 211 monitors tags, ids, or other indications of origin of the messages to determine that messages from the first agent 234 are received on the first single communication channel 215. In this example, if a message received on the first single communication channel 215 includes an identifier indicating the message originated at a different VM, the message is dropped. Similarly, if a message including an identifier of the first VM 232 is received on the second communication channel 217 or any other communication channel besides the first communication channel 215, the message is dropped.

The messaging cluster 211 may direct messages from the first and second VMs 232, 242 to various components of the control plane 210 based on characteristics of the control plane 210. The messaging cluster 211 may include different topics for sending and receiving messages on the first and second single communication channels 215, 217. In an example, the messaging cluster 211 may route messages in an operations topic, a requests topic, and a commands topic.

The control plane 210 includes an orchestrator 214 to orchestrate database management services. In some implementations, the orchestrator 214 may be implemented as a service or container. Similarly, other components of the control plane 210 may be implemented as services or containers. The orchestrator 214 may receive database management service requests from other components of the control plane 210. The orchestrator 214 generates operations and sends the operations and/or commands associated with the operations to the messaging cluster 211. In an example, the orchestrator receives a clone database request for the first VM 232, generates a clone database operation, and sends commands for generating a clone database for the first VM 232 to the messaging cluster 211 for sending to the first agent 234 using the first single communication channel 215.

The control plane includes a backup service 212. The backup service 212 may determine when to generate backups of the first and second VMs 232, 242 and/or when to generate clone databases for the first and second databases 236, 246. The backup service 212 may determine when to generate backups and/or clone databases based on service level agreements (SLAs). In an example, a first SLA for the first VM 232 may cause the backup service 212 to generate and send a backup request for the first VM 232 to the orchestrator 214 every day. In an example, a second SLA for the second VM 242 may cause the backup service 212 to generate and send a backup request for the second VM 242 to the orchestrator 214 every day.

The backup service 212 can coordinate replication of data from a primary database to a secondary database. The backup service 212 can designate a first database as the primary database and a second database as the secondary database and configure replication of data (e.g., synchronous or asynchronous) from the primary database to the secondary database. In an example, the backup service 212 designates the first database 236 as the primary database and the second database 246 as the secondary database such that data of the first database 236 is replicated to the second database 246 to provide a backup of the first database 236 on the second database 246. The backup service 212 can coordinate placement of observer VMs and execution of monitor processes by the first VM 232 and the second VM 242, as discussed herein. In an example, the backup service 212 causes an observer VM to be spawned (e.g., created, launched) on a cluster hosting the second VM 242 in response to a failure of a cluster hosting the first VM 232. In some implementations, separate services perform different aspects of functionality attributed herein to the backup service 212. In an example, a first service coordinates capture of snapshots and a second service coordinates placement and spawning of observer VMs.

The control plane includes a monitoring service 216. The monitoring service 216 may monitor a status of the first database 236 and/or a status of the second database 246. In some implementations, the second database 246 is a backup database of the first database 236 and the monitoring service 216 monitors the status of the first database 236 in order to determine when to recover the first database 236 using the second database 246 or to perform a failover to the second database 246. The monitoring service 216 may monitor the status of the first database 236 and/or the status of the second database 246 by monitoring messages between the control plane 210 and the first and second databases 236, 246. The monitoring service 216 may monitor the status of the first database 236 and/or the status of the second database 246 by causing monitor processes to be executed by the first agent 234 and/or the second agent 244. In an example, the monitoring service 216 causes the first agent 234 to execute a monitor process that monitors a health of an observer hosted in the cloud 240 to observe the first database 236. In this way, the observer can provide for failover from the first database 236 to the second database 246 by observing a failure of the first database 236 and the monitor process can provide for spawning of a new observer by observing a failure of the observer, thus providing multiple layers of resiliency.

The control plane 210 includes a user interface service 218. The user interface service 218 provides an interface for a user of the control plane 210. The user interface service 218 may expose data of the control plane 210 to the user. The user interface service 218 may expose only data associated with the user to the user. The user interface service 218 can display a status of the first VM 232, the first database 236, the second VM 242, and/or the second database 246. The user interface service can allow a user to provide input, such as preferences for placement of observers and/or placement of monitors.

The control plane 210 may include additional components not illustrated. Only the illustrated components are included for clarity. In some implementations, multiple instances of the control plane 210 may be implemented in order to provide database management services to additional virtual machines or databases. In some implementations, the components of the control plane 210 may be services which may be implemented in multiple instances. In this way, the control plane 210 is highly scalable to provide database management services to additional VMs.

In some implementations, the backup service 212 includes backup service entities, or instances on the control plane 210 that are created each time a database is provisioned. Each backup service entity is associated with a database and manages all database management tasks for the associated database. The backup service entity may be a logic construct that handles all data management aspects for the associated database. The backup service entity can handle the creation of backups for the database, the creation of snapshots, and the capture of logs. In some implementations, the backup service entity defines a service level agreement (SLA) or ingest an SLA to be applied to the database. The backup service entity can provide point-in-time recovery (PITR) for the database using the captured snapshots and logs. In an example, a user indicates, using the user interface service 218 that the database is to be restored to a particular point in time, and the backup service entity applies a corresponding snapshot and logs to the database to restore the database to the particular point in time. The backup service entity allows for management of data of the database, providing for users to export some or all of the data of the database (e.g., schema, tables, rows). The database entity can provide metadata management, allowing applications to use the database as a dedicated metadata store. The backup service entity can detect sensitive data in the database. In some implementations, the backup service entity can obscure or mask the sensitive data. The backup service entity may allow for users to specify who can access the database (e.g., access policy). The backup service entity can allow users to set data pipelines, such as data lakes. In an example, the backup service entity performs data processing on data in the database, or orchestrates data processing of the data in the database to send the data to a data store (e.g., data lake, data warehouse). In some implementations, the backup service entity provides data analytics corresponding to usage of the data in the database, an amount of data in the database, changes to the data in the database, and other information.

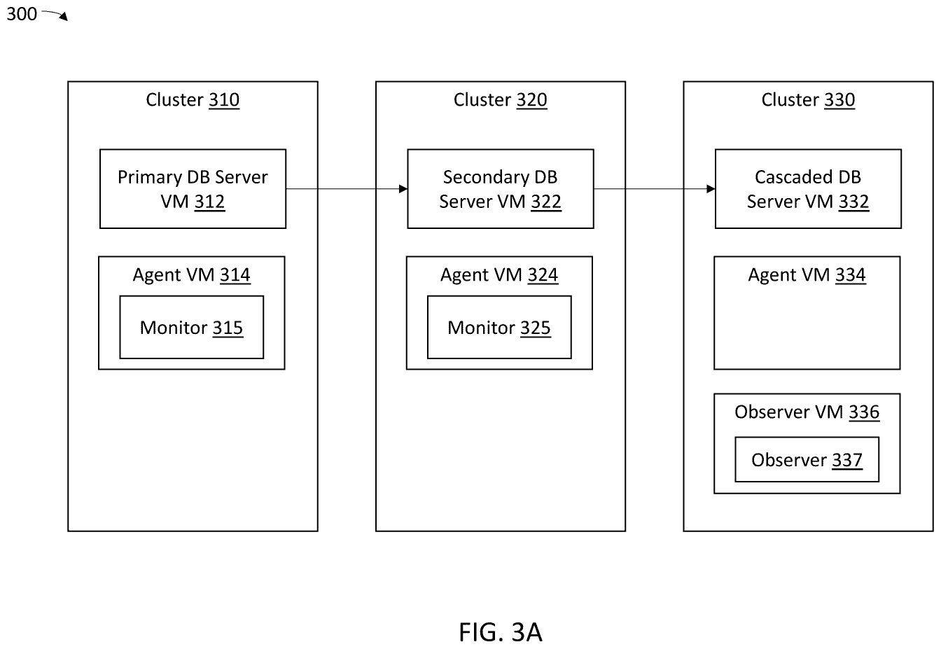

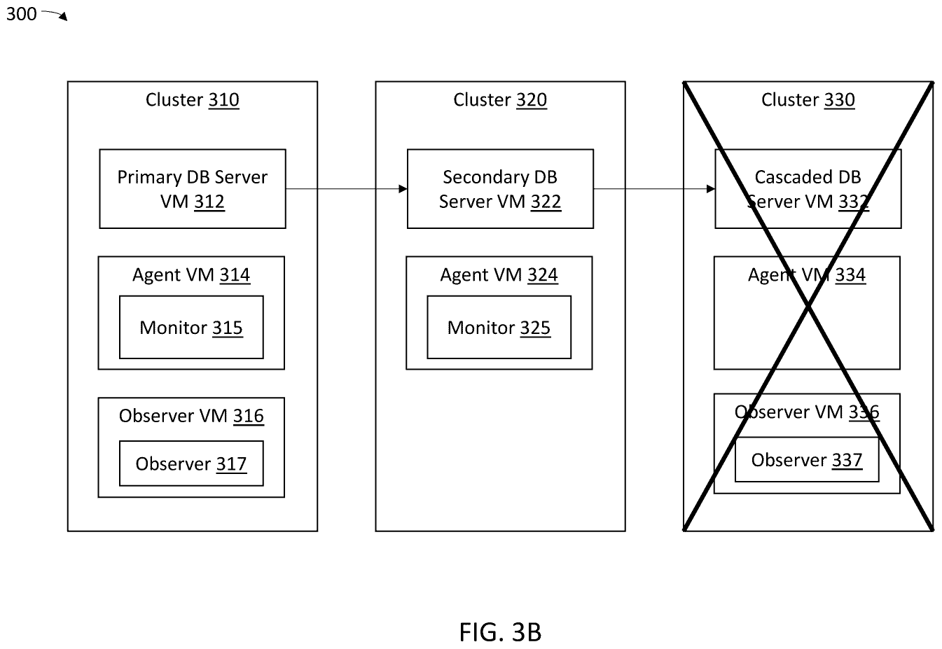

FIG. 3A is a block diagram of an example computing environment 300 including three clusters hosting a primary database, a secondary database, and a cascaded database. The computing environment 300 includes a first cluster 310, a second cluster 320, and a third cluster 330. Each of the clusters 310, 320, 330 may be similar to or implementations of the structure of the cluster 100 of FIG. 1. Each of the clusters 310, 320, 330 may be managed by the database management system 200 of FIG. 2. While clusters 310, 320, 330 are described herein as clusters, the clusters 310, 320, 330 can represent any computing environments for hosting the entities hosted on the clusters 310, 320, 330 and for performing the functionality attributed to the clusters 310, 320, 330.

The first cluster 310 hosts a primary database (DB) server VM 312 and an agent VM 314. The primary DB server VM 312 is a VM that hosts a primary database. The agent VM 314 is a virtual machine that executes commands from a control plane of a database management system, such as the database management system 200 of FIG. 2. The second cluster 320 hosts a secondary server VM 322 and an agent VM 324. The secondary DB server VM 322 is a VM that hosts a secondary database that is a secondary database to the primary database hosted by the primary DB server VM 312. Data of the primary database is replicated asynchronously and/or synchronously to the secondary database. The agent VM 324 is a virtual machine that executes commands from a control plane of a database management system, such as the database management system 200 of FIG. 2. The third cluster 330 hosts a cascaded DB server VM 332 and an agent VM 334. The cascaded DB server VM 332 is a VM that hosts a cascaded database that is a backup database to the primary database hosted by the primary DB server VM 312. Data of the primary database is replicated asynchronously and/or synchronously to the cascaded database. In some implementations, data of the secondary database is replicated to the cascaded database. The agent VM 334 is a virtual machine that executes commands from a control plane of a database management system, such as the database management system 200 of FIG. 2.

The third cluster 330 hosts an observer VM 336. The observer VM 336 executes an observer process 337 (“observer 337”) that monitors the primary database (e.g., the primary DB server VM 312), the secondary database (e.g., the secondary DB server VM 322), and the cascaded database (e.g., the cascaded DB server VM 332) to determine whether a failover from the primary database to the secondary database or to the cascaded database is needed. In an example, in the event of a failure of the primary DB server VM 312, the observer 337 triggers a failover from the primary database to the secondary database.

The agent VM 314 hosted on the first cluster 310 executes a first monitor process 315 (“first monitor 315”) and the agent VM 324 hosted on the second cluster 320 executes a second monitor process 325 (“second monitor 325”). The first monitor 315 and the second monitor 325 monitor each other, the observer 337, and network latency between the observer 337 and the primary DB server VM 312. The first monitor 315 and the second monitor 325 monitor an availability and health of the observer 337. The first monitor 315 and the second monitor 325 consume fewer computational resources than the observer 337. Furthermore, the first monitor 315 and the second monitor 325, by running on the agent VM 314 and the agent VM 324, respectively, use the virtualized resources already allocated to the agent VM 314 and the agent VM 324 without requiring any additional allocation or virtualization of resources. Thus, the first monitor 315 and the second monitor 325 represent a lightweight solution to increasing the resiliency of the automatic failover system. The first monitor 315 and the second monitor 325 can spawn a new observer or a new observer VM in response to failure of the observer 337.

Failure of the observer 337 can be based on unavailability and/or latency of the observer 337. The first monitor 315 and the second monitor 325 can determine failure of the observer 337 by transmitting messages to the observer 337 and observing responses from the observer 337. A lack of response can correspond to unavailability of the observer 337. A round trip time (RTT) between transmission of a message and receiving a response can correspond to network latency of the observer 337. If the RTT is above a predetermined threshold, the first monitor 315 and the second monitor 325 can determine a failure of the observer 337 due to latency.

The first monitor 315 and the second monitor 325 can determine a cause of a failure of the observer 337 to determine how to restart observation. If the failure of the observer 337 was due to a failure of the observer process 337 itself, a new observer process 337 is started. If the failure of the observer 337 was due to failure of the observer VM 336, a new observer VM is spawned on the third cluster 330. If the failure of the observer 337 was due to failure of the third cluster, a new observer VM is spawned on the first cluster 310 or the second cluster 320.

In some implementations, the first monitor 315 and the second monitor 325 spawn a new observer VM directly. In some implementations, the first monitor 315 and the second monitor 325 spawn a new observer VM by sending a new observer VM request to a control plane of a database management system which causes the new observer VM to be spawned. In some implementations, the first monitor 315 and the second monitor 325 transmit alerts to the control plane indicating failure of the observer VM 336 and the control plane causes a new observer VM to be spawned. In some implementations, the first monitor 315 and the second monitor 325 transmit data regarding the heath and availability of the observer 337 to the control plane and the control plane determines whether the observer 337 has failed and whether to spawn a new observer VM.

In some implementations, consensus between the first monitor 315 and the second monitor 325 is reached before spawning a new observer VM. In an example, the first monitor 315 and the second monitor 325 communicate with each other to establish the consensus. In an example, the first monitor 315 and the second monitor 325 transmit data and/or alerts to the control plane which determines whether there is consensus between the first monitor 315 and the second monitor 325. Reaching consensus between the first monitor 315 and the second monitor 325 before spawning a new observer VM prevents an issue with one of the first monitor 315 and the second monitor 325 from triggering spawning a new observer VM when the new observer VM is not needed. In an example, if the second cluster 320 is experiencing high network latency, the second monitor 325 may conclude that a latency between the primary database and the observer 337 is above a predetermined threshold and conclude that a new observer should be spawned. In this example, the first monitor 315 and the second monitor 325 are not in consensus, as the conclusion reached by the second monitor 325 is due to an issue with the second cluster 320, not the observer 337.

In response to a lack of consensus between the first monitor 315 and the second monitor 325, the first monitor 315 and the second monitor 325 perform an inter-monitor health check to identify issues with the first monitor 315 or the second monitor 325. In response to an issue with first monitor 315 or the second monitor 325, a new monitor process is spawned to ensure two monitors are monitoring the observer 337 and to provide inter-monitor monitoring. In an example, the control plane, in response to a lack of consensus between the first monitor 315 and the second monitor 325, transmits commands to the first monitor 315 and the second monitor 325 to determine each other's health and status. In this example, the control plane determines that the second monitor 325 is unstable or has latency above a predetermined threshold and sends a command to the agent VM 334 hosted on the third cluster 330 to spawn a monitor process to replace the second monitor 325.

FIG. 3B is a block diagram of the computing environment 300 of FIG. 3A after a failure of the third cluster 330. The first monitor 315 and the second monitor 325 determined that the observer 337 was unavailable due to failure of the third cluster 330 and, in response to the failure of the observer 337 being due to the failure of the third cluster 330, spawned a new observer VM 316 on the first cluster 310. The new observer VM 316 executes an observer process 317 (“observer 317”) which monitors the primary database and the secondary database. In some implementations, the first monitor 315 and the second monitor 325 sent data and/or alerts to a control plane of a database management system which determined that the new observer VM 316 should be spawned on the first cluster 310 and transmitted a command to the agent VM 314 to spawn the new observer VM 316 on the first cluster 310.

Example responses to failure conditions detected using the first monitor 315 and the second monitor 325 are summarized in Table 1.

TABLE 1

| Failure | First | Second | Third |
|---|---|---|---|
| Condition | Cluster | Cluster | Cluster |
| Steady state | | | Observer |
| (no failure) | Monitor | Monitor | |
| Observer | | | Observer |
| VM failure | | | (New) |
| | Monitor | Monitor | |
| Third | Observer | | |
| Cluster | (New) | | |
| failure | Monitor | Monitor | |
| First | | | Observer |
| Monitor | | Monitor | Monitor |
| failure | | | (New) |
| Second | | | Observer |
| Monitor | Monitor | | Monitor |
| failure | | | (New) |

As indicated in Table 1, in the steady state illustrated in FIG. 3A, the first monitor 315 runs on the first cluster 310, the second monitor 325 runs on the second cluster 320, and the observer 337 runs on the third cluster 330. As indicated in Table 1, in the event of a failure of the observer VM 336, a new observer VM is spawned on the third cluster 330. As indicated in Table 1, in the event of a failure of the third cluster 330, a new observer VM is spawned on the first cluster 310. As indicated in Table 1, in the event of a failure of the first monitor 315, a new monitor is spawned on the third cluster 330. As indicated in Table 1, in the event of a failure of the second monitor 325, a new monitor is spawned on the third cluster 330.

By dynamically spawning the new observer VM 316 in response to the failure of the third cluster 330, compute and storage resources are conserved. The compute and storage resources used by the new observer VM 316 are not allocated or assigned to the new observer VM 316 until the new observer VM 316 is spawned. In this way, the compute and storage resources are available on the first cluster 310 until the new observer VM 316 is spawned. This represents a significant conservation of compute and storage resources relative to running backup observer VMs on the first cluster 310 and/or the second cluster 320. By dynamically spawning the new observer VM 316, as opposed to activating a dormant observer VM, the compute and storage resources of the new observer VM 316 are available on the first cluster 310 for other uses until the new observer VM 316 is spawned.

In some implementations, the first cluster 310 stores a configuration file including a configuration for the new observer VM 316. The configuration for the new observer VM 316 indicates parameters of the new observer VM 316 such as how it monitors the primary, secondary, and/or cascaded databases, including latency and health thresholds for initiating an automatic failover. The configuration for the new observer VM 316 can include credentials for the new observer VM 316. Spawning the new observer VM 316 can include retrieving the configuration file and applying the configuration file to the new observer VM 316. In this way, the new observer VM 316 is spawned in such a way that it is able to seamlessly integrate into the automatic failover system to provide monitoring of the primary, secondary, and/or cascaded databases.

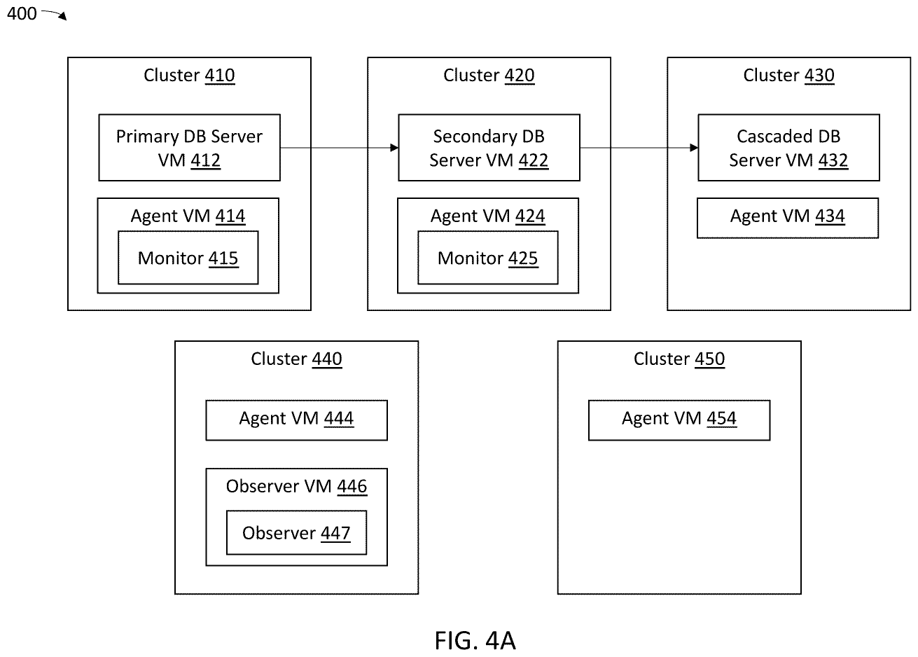

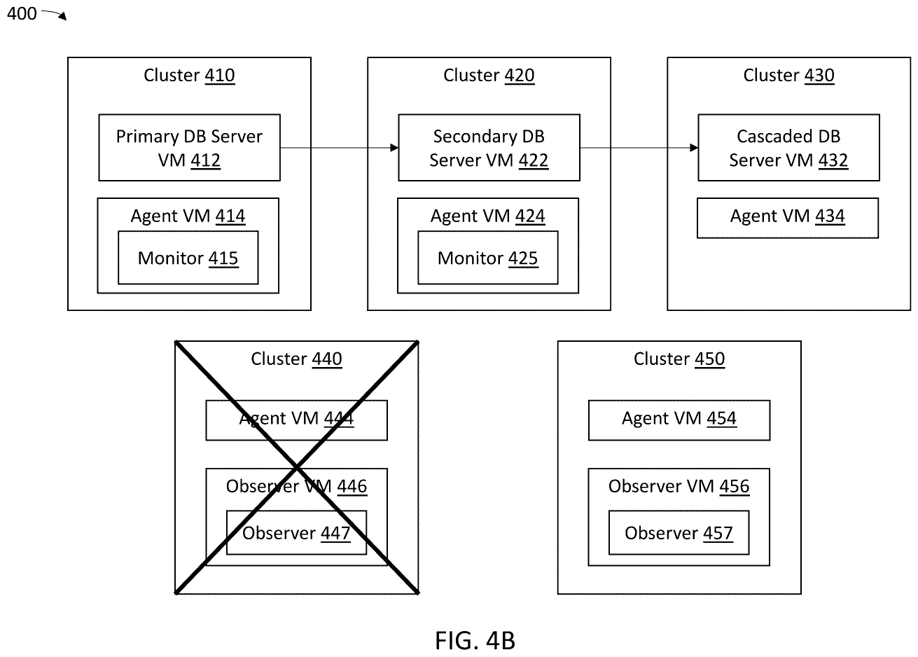

FIG. 4A is a block diagram of an example computing environment 400 including five clusters hosting a primary database, a secondary database, and a cascaded database. The five clusters include a first cluster 410, a second cluster 420, a third cluster 430, a fourth cluster 440, and a fifth cluster 450. Each of the clusters 410, 420, 430, 450 may be similar to or implementations of the structure of the cluster 100 of FIG. 1. Each of the clusters 410, 420, 430, 450 may be managed by the database management system 200 of FIG. 2. While clusters 310, 320, 330 are described herein as clusters, the clusters 310, 320, 330 can represent any computing environments for hosting the entities hosted on the clusters 310, 320, 330 and for performing the functionality attributed to the clusters 310, 320, 330.

The first cluster 410 hosts a primary database (DB) server VM 412 and an agent VM 414. The primary DB server VM 412 is a VM that hosts a primary database. The agent VM 414 is a virtual machine that executes commands from a control plane of a database management system, such as the database management system 200 of FIG. 2. The second cluster 420 hosts a secondary server VM 422 and an agent VM 424. The secondary DB server VM 422 is a VM that hosts a secondary database that is a secondary database to the primary database hosted by the primary DB server 412. Data of the primary database is replicated asynchronously and/or synchronously to the secondary database. The agent VM 424 is a virtual machine that executes commands from a control plane of a database management system, such as the database management system 200 of FIG. 2. The third cluster 430 hosts a cascaded DB server VM 432 and an agent VM 434. The cascaded DB server VM 432 is a VM that hosts a cascaded database that is a backup database to the primary database hosted by the primary DB server 412. Data of the primary database is replicated asynchronously and/or synchronously to the cascaded database. In some implementations, data of the secondary database is replicated to the cascaded database. The agent VM 434 is a virtual machine that executes commands from a control plane of a database management system, such as the database management system 200 of FIG. 2.

The fourth cluster 440 hosts an agent VM 444 that is a virtual machine that executes commands from a control plane of a database management system, such as the database management system 200 of FIG. 2. The fifth cluster 450 hosts an agent VM 454 that is a virtual machine that executes commands from a control plane of a database management system, such as the database management system 200 of FIG. 2. In some implementations, the fourth cluster 440 and the fifth cluster 450 do not host databases. In some implementations, the fourth cluster 440 and the fifth cluster 450 host databases that serve as additional backups to the primary database.

The fourth cluster 440 hosts an observer VM 446. The observer VM 446 executes an observer process 447 (“observer 447”) that monitors the primary database (e.g., the primary DB server VM 412), the secondary database (e.g., the secondary DB server VM 422), and the cascaded database (e.g., the cascaded DB server VM 432) to determine whether a failover from the primary database to the secondary database or to the cascaded database is needed. In an example, in the event of a failure of the primary DB server VM 412, the observer 447 triggers a failover from the primary database to the secondary database.

The agent VM 414 hosted on the first cluster 410 executes a first monitor process 415 (“first monitor 415”) and the agent VM 424 hosted on the second cluster 420 executes a second monitor process 425 (“second monitor 425”). The first monitor 415 and the second monitor 425 may be the same as or similar to the first monitor 315 and the second monitor 325 of FIGS. 3A and 3B. The first monitor 415 and the second monitor 425 monitor each other, the observer 447, and network latency between the observer 447 and the primary DB server VM 412. The first monitor 415 and the second monitor 425 monitor an availability and health of the observer 437. The first monitor 415 and the second monitor 425 consume fewer computational resources than the observer 437. Furthermore, the first monitor 415 and the second monitor 425, by running on the agent VM 414 and the agent VM 424, respectively, use the virtualized resources already allocated to the agent VM 414 and the agent VM 424 without requiring any additional allocation or virtualization of resources. Thus, the first monitor 415 and the second monitor 425 represent a lightweight solution to increasing the resiliency of the automatic failover system.

The first monitor 415 and the second monitor 425 can spawn a new observer 437 or a new observer VM 436 in response to failure of the observer 437. In an example, the first monitor 415 and the second monitor 425 spawn a new observer VM on the fourth cluster 440 or the fifth cluster 450 in response to a failure of the observer VM 446. In an example, the first monitor 415 and the second monitor 425 spawn a new observer VM on the fifth cluster 450 in response to a failure of the fourth cluster 440, as illustrated in FIG. 4B.

FIG. 4B is a block diagram of the computing environment 400 of FIG. 4A after a failure of the fourth cluster 440. The first monitor 415 and the second monitor 425 determined that the observer 447 was unavailable due to failure of the fourth cluster 440 and, in response to the failure of the observer 447 being due to the failure of the fourth cluster 440, spawned a new observer VM 456 on the fifth cluster 450. The new observer VM 456 executes an observer process 457 (“observer 457”) which monitors the primary database and the secondary database. In some implementations, the first monitor 415 and the second monitor 225 sent data and/or alerts to a control plane of a database management system which determined that the new observer VM 456 should be spawned on the fifth cluster 450 and transmitted a command to the agent VM 454 to spawn the new observer VM 456 on the fifth cluster 450.

The spawning of the new observer VM 456 on the fifth cluster 450 is similar to the spawning of the new observer VM 316 on the first cluster 310 of FIG. 3B. The first monitor 415 and the second monitor 425 and/or the control plane can determine where to place the new observer VM 456 based on a number of clusters and the locations of the primary database, secondary database, and/or cascaded database.

Example responses to failure conditions detected using the first monitor 415 and the second monitor 425 are summarized in Table 2.

TABLE 2

| Failure | First | Second | Third | Fourth | Fifth |
|---|---|---|---|---|---|
| Condition | Cluster | Cluster | Cluster | Cluster | Cluster |
| Steady state | | | | Observer | |
| (no failure) | Monitor | Monitor | | | |
| Observer | | | | Observer | |
| VM failure | Monitor | Monitor | | (New) | |
| Fourth | | | | | Observer |
| Cluster | | | | | (New) |
| failure | Monitor | Monitor | | | |
| First | | | | Observer | |
| Monitor | | Monitor | Monitor | | Monitor |
| failure | | | (New - | | (New - |
| | | | Option 1) | | Option 2) |
| Second | | | | Observer | |
| Monitor | Monitor | | Monitor | | Monitor |
| failure | | | (New - | | (New - |
| | | | Option 1) | | Option 2) |

As indicated in Table 2, in the steady state illustrated in FIG. 4A, the first monitor 415 runs on the first cluster 410, the second monitor 425 runs on the second cluster 420, and the observer 447 runs on the fourth cluster 440. As indicated in Table 2, in the event of a failure of the observer VM 446, a new observer VM is spawned on the fifth cluster 450. As indicated in Table 1, in the event of a failure of the fourth cluster 440, a new observer VM is spawned on the fifth cluster 450. As indicated in Table 1, in the event of a failure of the first monitor 415, a new monitor is spawned on the third cluster 430 or the fifth cluster 450. As indicated in Table 2, in the event of a failure of the second monitor 325, a new monitor is spawned on the third cluster 430 or the fifth cluster.

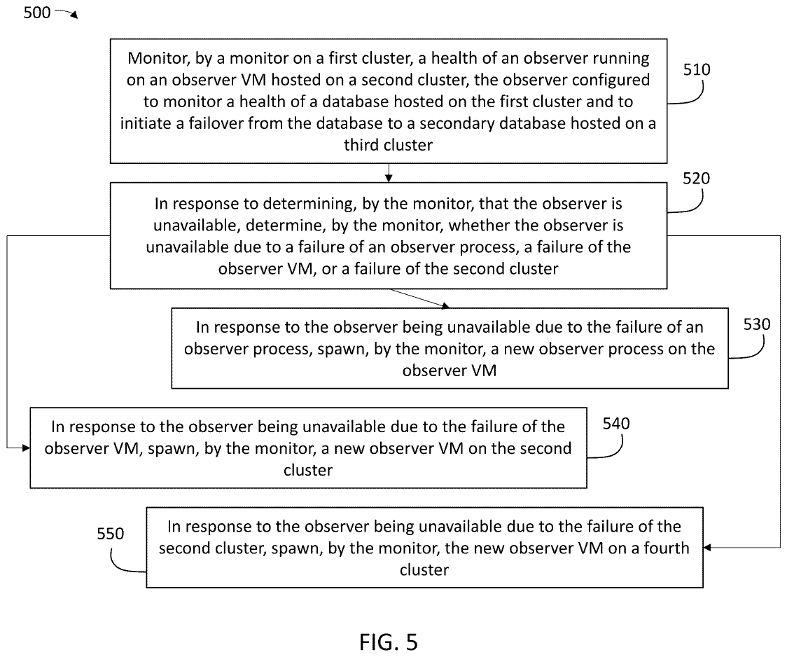

FIG. 5 illustrates operations of a flow chart of an example method 500 for dynamically spawning observer virtual machines (VMs) based on monitor processes. The method 500 can include more, fewer, or different operations than shown. One or more operations can be performed in the order shown, in a different order, or concurrently. The method 500 may be performed by the computing environment 300 of FIGS. 3A and 3B and/or the computing environment 400 of FIGS. 4A and 4B.

At operation 510, a monitor on a first cluster monitors a health of an observer running on an observer VM hosted on a second cluster, the observer configured to monitor a health of a primary database hosted on the first cluster and to initiate a failover from the primary database to a secondary database hosted on a third cluster. The secondary database can be a backup database for the primary database. Data of the primary database can be replicated synchronously and/or asynchronously to the secondary database. The secondary database can take over application service from the primary database if the primary database fails to prevent data loss and application downtime. The observer can trigger an automatic failover from the primary database to the secondary database to quickly transfer application service from the primary database to the secondary database if the primary database fails.

Monitoring, by the monitor, the health of the observer can include monitoring a stability and/or availability of the observer and/or a latency of transmissions to and from the observer. Thus, the monitor can generate alerts and/or execute actions (e.g., spawning a new observer) based on the observer being unresponsive or a latency of transmissions to and/or from the observer being above a predetermined threshold. In an example, the monitor transmits messages to the observer or a VM hosting the observer and monitors a round-trip-time (RTT) to receive an acknowledgment or response from the observer or its VM. In this example, if the RTT is above a predetermined threshold, the monitor generates an alert and/or executes actions.

In some implementations, the monitor consumes fewer computational resources and has a smaller footprint (i.e., smaller size) than the observer. In some implementations, the monitor runs on a VM hosted on the first cluster that is separate from a database VM (e.g., database server VM) hosted on the first cluster, where the database server VM hosts the primary database. By running on the VM (e.g., agent VM), the monitor can use the resources (e.g., compute resources, storage resources) allocated to the VM, without requiring any additional allocation or virtualization of resources. The VM hosting the monitor can be an agent (e.g., execute an agent process) of a control plane of a database management system. The monitor can transmit data (e.g., health of the observer) and/or alerts (e.g., observer unavailable) to the control plane. The control plane can determine actions to be executed in response to the health of the observer or the unavailability of the observe. In an example, the control plane transmits a command to the monitor, the VM hosting the monitor, or the agent process hosted on the VM to spawn (i.e., launch, start) a new observer (e.g., observer VM) in response to a failure of the observer.

At operation 520, in response to determining, by the monitor, that the observer is unavailable, the monitor determines whether the observer is unavailable due to a failure of an observer process, a failure of the observer VM, or a failure of the second cluster (i.e., a cause of the observer being unavailable). Determining the cause of the observer being unavailable or the observer failure can include analyzing messages transmitted to and received from the observer. In an example, if a message to the observer process does not result in an acknowledgement from the observer process, but a message to the observer VM results in an acknowledgement from the observer VM, the observer failure is due to a failure of the observer process. In an example, if a message to the observer VM does not result in an acknowledgement from the observer VM, but a message to the second cluster results in an acknowledgement from the second cluster, the observer failure is due to a failure of the observer VM. In an example, if a message to the second cluster does not result in an acknowledgement from the second cluster, the observer failure is due to a failure of the second cluster.

At operation 530, in response to the observer being unavailable due to the failure of an observer process, the monitor spawns a new observer process on the observer VM. In some implementations, the monitor transmits a command to the observer VM to spawn a new observer process. In some implementations, the monitor transmits an alert to the control plane of the failure of the observer process, receives a command to spawn a new observer process from the control plane, and transmits a command to the observer VM to spawn the new observer process.

At operation 540, in response to the observer being unavailable due to the failure of the observer VM, the monitor spawns a new observer VM on the second cluster. In some implementations, the monitor transmits a command to the second cluster or a VM hosted on the second cluster to spawn a new observer VM. In some implementations, the monitor transmits an alert to the control plane of the failure of the observer VM, receives a command to spawn a new observer VM on the second cluster from the control plane, and transmits a command to a VM running an agent process of the control plane on the second cluster to spawn the new observer VM on the second cluster. In some implementations, the control plane transmits the command to the VM running the agent process on the second cluster to spawn the new observer VM.

At operation 550, in response to the observer being unavailable due to the failure of the second cluster, the monitor spawns the new observer VM on a fourth cluster. In some implementations, the fourth cluster is the same as the first cluster. In some implementations, the fourth cluster is an additional cluster separate from the first, second, and third clusters. The monitor, and/or the control plane, can determine on which cluster the new observer VM should be spawned based on a number of available clusters, the location of the primary database, the location of the secondary database, the location of any cascaded databases, and/or the location of the monitor or monitors. In some implementations, the monitor transmits a command to the fourth cluster or a VM hosted on the fourth cluster to spawn a new observer VM. In some implementations, the monitor transmits an alert to the control plane of the failure of the observer VM, receives a command to spawn a new observer VM on the fourth cluster from the control plane, and transmits a command to a VM running an agent process of the control plane on the fourth cluster to spawn the new observer VM on the fourth cluster. In some implementations, the control plane transmits the command to the VM running the agent process on the fourth cluster to spawn the new observer VM.

In some implementations, the method 500 includes retrieving a configuration file of the observer VM and applying the configuration file to the new observer VM. The configuration file can include a configuration for the observer VM. The configuration for the observer VM indicates parameters of the observer VM such as how it monitors the primary, secondary, and/or cascaded databases, including latency and health thresholds for initiating an automatic failover. The configuration for the observer VM can include credentials for the observer VM. Spawning the new observer VM can include retrieving the configuration file and applying the configuration file to the new observer VM. In this way, the new observer VM is spawned in such a way that it is able to seamlessly integrate into the automatic failover system to provide monitoring of the primary, secondary, and/or cascaded databases. In some implementations, the configuration for the new observer VM differs from the configuration of the observer VM, such as a location of the new observer VM. The monitor and/or the control plane can modify the configuration of the observer VM to generate the configuration for the new observer VM.

In some implementations, the method 500 includes monitoring, by a second monitor on the third cluster, a health of the monitor and the health of the observer. In some implementations, the method 500 includes monitoring, by the monitor, a health of the second monitor. The monitor and the second monitor, by monitoring each other, can ensure that they are accurately monitoring the observer. In some implementations, the monitor and the second monitor continuously or periodically monitor each other's health. In some implementations, the monitor and the second monitor initiate monitoring of each other's health in response to a disagreement between the monitor and the second monitor and/or a command from the control plane. In an example, the monitor determines that the observer is unavailable but the second monitor determines that the observer is available, triggering an inter-monitor health check where the monitor and the second monitor initiate monitoring of each other's health.

In some implementations, the method 500 includes, in response to the monitor being unavailable, spawning, by the second monitor, an additional monitor on the second cluster or the fourth cluster. The additional monitor can be spawned on the second cluster or the fourth cluster to avoid issues caused by the first cluster. The additional monitor can replace the monitor and perform inter-monitor health checks with the second monitor. The additional monitor can be spawned on the second cluster or the fourth cluster based on a location of the second monitor, a number of available clusters, locations of the databases, and/or a location of the observer. In some implementations, the additional monitor is spawned based on a latency of transmission to and/or from the monitor being above a predetermined latency threshold.

In some implementations, determining that the observer is unavailable includes reaching a consensus between the monitor and the second monitor. The consensus between the monitor and the second monitor comprises similar or identical determinations or data provided by the monitor and the second monitor. In an example, consensus is reached between the monitor and the second monitor when both the monitor and the second monitor determine that the observer is available, or when both the monitor and the second monitor determine that the observer is not available. Reaching consensus between the monitor and the second monitor guards against issues with the monitor or the second monitor from causing false positives in determinations of observer failure. In an example, a determination that the observer has failed due to latency above a predetermined threshold can indicate that the observer has failed or that the relevant monitor has failed and the monitor experiencing the high latency. In some implementations, the monitor and the second monitor communicate among themselves to reach the consensus. In some implementations, the control plane determines whether there is consensus between the monitor and the second monitor.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a non-transitory computer-readable storage device, a non-transitory computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a model stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the monitoring device 102) to perform actions by operating on input data and generating an output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method comprising:
monitoring, by a monitor on a first cluster, a health of an observer running on an observer virtual machine (VM) hosted on a second cluster, the observer configured to monitor a health of a primary database hosted on the first cluster and to initiate a failover from the primary database to a secondary database hosted on a third cluster;
in response to determining, by the monitor, that the observer is unavailable, determining, by the monitor, whether the observer is unavailable due to a failure of an observer process, a failure of an observer VM, or a failure of the second cluster;
in response to the observer being unavailable due to the failure of the observer VM, spawning, by the monitor, a new observer VM on the second cluster; and
in response to the observer being unavailable due to the failure of the second cluster, spawning, by the monitor, the new observer VM on a fourth cluster.

2. The method of claim 1, wherein the monitor consumes fewer computational resources than the observer.

3. The method of claim 1, wherein the monitor runs on a VM hosted on the first cluster that is separate from a database server VM hosted on the first cluster, wherein the database server VM hosts the primary database.

4. The method of claim 1, further comprising:
retrieving a configuration file including a configuration of the observer VM; and
applying the configuration file to the new observer VM.

5. The method of claim 1, further comprising:
monitoring, by a second monitor on the third cluster, a health of the monitor and the health of the observer; and
monitoring, by the monitor, a health of the second monitor.

6. The method of claim 5, further comprising, in response to the monitor being unavailable, spawning, by the second monitor, an additional monitor on the second cluster or the fourth cluster.

7. The method of claim 5, wherein determining that the observer is unavailable includes reaching a consensus between the monitor and the second monitor.

8. An apparatus comprising:
one or more processors; and
a non-transitory, computer-readable medium including instructions which, when executed by the one or more processors, cause the one or more processors to:
monitor, by a monitor on a first cluster, a health of an observer running on an observer virtual machine (VM) hosted on a second cluster, the observer configured to monitor a health of a primary database hosted on the first cluster and to initiate a failover from the primary database to a secondary database hosted on a third cluster;
in response to determining, by the monitor, that the observer is unavailable, determine, by the monitor, whether the observer is unavailable due to a failure of an observer process, a failure of an observer VM, or a failure of the second cluster;
in response to the observer being unavailable due to the failure of the observer VM, spawn, by the monitor, a new observer VM on the second cluster; and
in response to the observer being unavailable due to the failure of the second cluster, spawn, by the monitor, the new observer VM on a fourth cluster.

9. The apparatus of claim 8, wherein the monitor consumes fewer computational resources than the observer.

10. The apparatus of claim 8, wherein the monitor runs on a VM hosted on the first cluster that is separate from a database server VM hosted on the first cluster, and wherein the database server VM hosts the primary database.

11. The apparatus of claim 8, wherein the instructions further cause the one or more processors to:
retrieve a configuration file including a configuration of the observer VM; and
apply the configuration file to the new observer VM.

12. The apparatus of claim 8, wherein the instructions further cause the one or more processors to:
monitor, by a second monitor on the third cluster, a health of the monitor and the health of the observer; and
monitor, by the monitor, a health of the second monitor.

13. The apparatus of claim 12, wherein the instructions further cause the one or more processors to, in response to the monitor being unavailable, spawn, by the second monitor, an additional monitor on the second cluster or the fourth cluster.

14. The apparatus of claim 12, wherein determining that the observer is unavailable includes reaching a consensus between the monitor and the second monitor.

15. A non-transitory, computer-readable medium including instructions which, when executed by one or more processors, cause the one or more processors to:
monitor, by a monitor on a first cluster, a health of an observer running on an observer virtual machine (VM) hosted on a second cluster, the observer configured to monitor a health of a primary database hosted on the first cluster and to initiate a failover from the primary database to a secondary database hosted on a third cluster;
in response to determining, by the monitor, that the observer is unavailable, determine, by the monitor, whether the observer is unavailable due to a failure of an observer process, a failure of an observer VM, or a failure of the second cluster;
in response to the observer being unavailable due to the failure of the observer VM, spawn, by the monitor, a new observer VM on the second cluster; and
in response to the observer being unavailable due to the failure of the second cluster, spawn, by the monitor, the new observer VM on a fourth cluster.

16. The non-transitory, computer-readable medium of claim 15, wherein the monitor consumes fewer computational resources than the observer.

17. The non-transitory, computer-readable medium of claim 15, wherein the monitor runs on a VM hosted on the first cluster that is separate from a database server VM hosted on the first cluster, and wherein the database server VM hosts the primary database.

18. The non-transitory, computer-readable medium of claim 15, wherein the instructions further cause the one or more processors to:
retrieve a configuration file including a configuration of the observer VM; and
apply the configuration file to the new observer VM.

19. The non-transitory, computer-readable medium of claim 15, wherein the instructions further cause the one or more processors to:
monitoring, by a second monitor on the third cluster, a health of the monitor and the health of the observer; and
monitoring, by the monitor, a health of the second monitor.

20. The non-transitory, computer-readable medium of claim 19, wherein the instructions further cause the one or more processors to, in response to the monitor being unavailable, spawn, by the second monitor, an additional monitor on the second cluster or the fourth cluster.
